(19) United States
(12) Patent Application Publication
(10) Pub. No.: US 2026/0054528 A1
(43) Pub. Date: Feb. 26, 2026

(54) TIRE WEAR NOTIFICATION SYSTEM

(71) Applicant: GM GLOBAL TECHNOLOGY OPERATIONS LLC, Detroit, MI (US)

(72) Inventors: Michael D. Alarcon, Markham (CA); Arash Aminianrazavi, Newmarket (CA); Diya Isac, Whitby (CA); Russell A. Patenaude, Macomb Township, MI (US); Mengxuan Li, Toronto (CA); Rijul Singla, North York (CA)

(73) Assignee: GM GLOBAL TECHNOLOGY OPERATIONS LLC, Detroit, MI (US)

(21) Appl. No.: 18/813,404

(22) Filed: Aug. 23, 2024

(51) Int. Cl. B60C 11/24

(52) U.S. Cl. CPC B60C 11/246

(57) ABSTRACT

In an exemplary embodiment, methods and systems are provided for monitoring tire tread for tires of a vehicle, including by obtaining, via one or more sensors of the vehicle, images of tread for the tires of the vehicle after tire wear monitoring is initiated for the vehicle; determining, via a processor that is coupled to the one or more sensors, a depth of the tread for the tires of the vehicle, using the images, when tire wear monitoring is initiated for the vehicle; and providing a notification for a user of the vehicle as to the depth of the tread for the tires of the vehicle, based on instructions provided by the processor.

### INTRODUCTION

The technical field generally relates to platforms such as vehicles and, more specifically, to methods and systems for monitoring tire wear and for providing notifications regarding the tire wear.

Many vehicles include tires that are installed on corresponding wheels of the vehicle. However, in certain situations, existing techniques may not provide for optimal monitoring of wear on the tire in certain situations.

Accordingly, it is desirable to provide improved methods and systems for monitoring tire wear for vehicles.

### SUMMARY

In an exemplary embodiment, a method is provided of monitoring tire tread for tires of a vehicle, the method including obtaining, via one or more sensors of the vehicle, images of tread for the tires of the vehicle after tire wear monitoring is initiated for the vehicle; determining, via a processor that is coupled to the one or more sensors, a depth of the tread for the tires of the vehicle, using the images, when tire wear monitoring is initiated for the vehicle; and providing a notification for a user of the vehicle as to the depth of the tread for the tires of the vehicle, based on instructions provided by the processor.

Also in an exemplary embodiment, the step of obtaining the images of the tread includes obtaining the images from one or more cameras of the vehicle; and the step of determining the depth of the tread includes determining, via the processor, the depth of the tread using camera images from the one or more cameras in connection with a calibrated camera projection matrix.

Also in an exemplary embodiment, the step of obtaining the images of the tread includes obtaining the images from a plurality of cameras of the vehicle, including a first camera proximate a side view mirror of the vehicle, and further including a second camera on an underbody of the vehicle.

Also in an exemplary embodiment, the method further includes providing, via the processor, instructions for movement of wheels of the vehicle during initiating of monitoring of the tread, to thereby allow for clarity of view of the tread of the tires via the one or more cameras and repeatability of generation of the images of the tread.

Also in an exemplary embodiment, the instructions are provided via the processor to the user of the vehicle via a display of the vehicle for the user to engage a steering wheel of the vehicle, to thereby move the wheels of the vehicle and allow for the clarity of view of the tread of the tires via the one or more cameras and repeatability of generation of the images of the tread.

Also in an exemplary embodiment, the instructions are provided via the processor to one or more actuators of the vehicle for autonomous movement of the wheels of the vehicle and allow for the clarity of view of the tread of the tires via the one or more cameras and repeatability of generation of the images of the tread.

Also in an exemplary embodiment, the method further includes storing, in computer memory, a tire tread pattern for the tires based on the images of the tread, in accordance with instructions provided by the processor.

Also in an exemplary embodiment, the method further includes determining, via the processor, decolorization of the tires based on the images; and adjusting, via the processor, the tire tread pattern based on the determining of the decolorization for storing in the computer memory.

Also in an exemplary embodiment, the method further includes determining, via the processor based on the tire tread pattern, whether tire rotation, replacement, or both are recommended, including based on whether the tire tread pattern is representative of uneven tread depth between front tires versus rear tears, between left tires versus right tires, or both.

Also in an exemplary embodiment, the method further includes storing, in computer memory, an identification of a tire pressure monitoring system (TPMS) identification for the tires, for identification of a particular tire for recognizing whether the particular tire has been replaced or rotated, in accordance with instructions provided by the processor.

Also in an exemplary embodiment, the method further includes determining, via the processor, whether sufficient light is present for obtaining the images of the tread; and automatically activating a light system outside the vehicle for illumination of the tires while the images of the tread are obtained, in accordance with instructions provided by the processor.

Also in an exemplary embodiment, the method further includes obtaining additional sensor data from one or more additional sensors of the vehicle, including as to values of time of acceleration, braking, tire pressure, terrain of roadways in which the vehicle has travelled, and outside air temperature surrounding the vehicle as the vehicle has been operated; wherein the tire wear monitoring is initiated with a frequency that is based upon the additional sensor data for the vehicle, including each of the acceleration, braking, tire pressure, terrain of roadways in which the vehicle has travelled, and the outside air temperature surrounding the vehicle as the vehicle has been operated.

In another exemplary embodiment, a system is provided for monitoring tire tread for tires of a vehicle, the system including one or more sensors of the vehicle and a processor. The one or more sensors are configured to obtain images of tread for the tires of the vehicle after tire wear monitoring is initiated for the vehicle. The processor is coupled to the one or more sensors and that is configured to at least facilitate determining a depth of the tread for the tires of the vehicle, using the images, when tire wear monitoring is initiated for the vehicle; and providing a notification for a user of the vehicle as to the depth of the tread for the tires of the vehicle, based on instructions provided by the processor.

Also in an exemplary embodiment, the one or more sensors include a plurality of cameras of the vehicle, including a first camera disposed proximate a side view mirror of the vehicle; and a second camera disposed on an underbody of the vehicle; and the processor is further configured to at least facilitate determining the depth of the tread using camera images from the plurality of cameras in connection with a calibrated camera projection matrix.

Also in an exemplary embodiment, the processor is further configured to at least facilitate providing instructions for movement of wheels of the vehicle during initiating of monitoring of the tread, to thereby allow for clarity of view of the tread of the tires via the plurality of cameras. and repeatability of generation of the images of the tread.

Also in an exemplary embodiment, the processor is further configured to at least facilitate storing, in computer memory, a tire tread pattern for the tires based on the images of the tread, in accordance with instructions provided by the processor; and determining, based on the tire tread pattern, whether tire rotation, replacement, or both are recommended, including based on whether the tire tread pattern is representative of uneven tread depth between front tires versus rear tears, between left tires versus right tires, or both.

Also in an exemplary embodiment, the stem further includes one or more additional sensors of the vehicle that are configured to obtain additional sensor data, including as to values of time of acceleration, braking, tire pressure, terrain of roadways in which the vehicle has travelled, and outside air temperature surrounding the vehicle as the vehicle has been operated; and the processor is further configured to at least facilitate initiating the tire wear monitoring with a frequency that is based upon the additional sensor data for the vehicle, including each of the acceleration, braking, tire pressure, terrain of roadways in which the vehicle has travelled, and the outside air temperature surrounding the vehicle as the vehicle has been operated.

In another exemplary embodiment, a vehicle is provided that includes one or more wheels; one or more sensors, and a processor. The one or more tires are disposed on the one or more wheels. The one or more sensors are configured to obtain images of tread for the tires after tire wear monitoring is initiated for the vehicle. The processor is coupled to the one or more sensors and that is configured to at least facilitate determining a depth of the tread for the tires of the vehicle, using the images, when tire wear monitoring is initiated for the vehicle; and providing a notification for a user of the vehicle as to the depth of the tread for the tires of the vehicle, based on instructions provided by the processor.

Also in an exemplary embodiment, the one or more sensors include a plurality of cameras of the vehicle, including a first camera disposed proximate a side view mirror of the vehicle; and a second camera disposed on an underbody of the vehicle; and the processor is further configured to at least facilitate providing instructions for movement of wheels of the vehicle during initiating of monitoring of the tread, to thereby allow for clarity of view of the tread of the tires via the plurality of cameras and repeatability of generation of the images of the tread; and determining the depth of the tread using camera images from the plurality of cameras in connection with a calibrated camera projection matrix.

Also in an exemplary embodiment, the vehicle further includes one or more additional sensors that are configured to obtain additional sensor data for the vehicle, including as to values of time of acceleration, braking, tire pressure, terrain of roadways in which the vehicle has travelled, and outside air temperature surrounding the vehicle as the vehicle has been operated; and the processor is further configured to at least facilitate initiating the tire wear monitoring with a frequency that is based upon the additional sensor data for the vehicle, including each of the acceleration, braking, tire pressure, terrain of roadways in which the vehicle has travelled, and the outside air temperature surrounding the vehicle as the vehicle has been operated.

### DESCRIPTION OF THE DRAWINGS

The present disclosure will hereinafter be described in conjunction with the following drawing figures, wherein like numerals denote like elements, and wherein:

FIG. 1 is a functional block diagram of a system that includes a vehicle with a plurality of wheels with accompanying tires, as well as a control system for monitoring wear of the tires, in accordance with exemplary embodiments;

FIG. 2 is a flowchart of a process for monitoring wear of tires for a vehicle, and that can be implemented in connection with the system and vehicle of FIG. 1, including the control system thereof, in accordance with an exemplary embodiment; and

FIG. 3 is an additional, more detailed flowchart of the process of FIG. 2, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

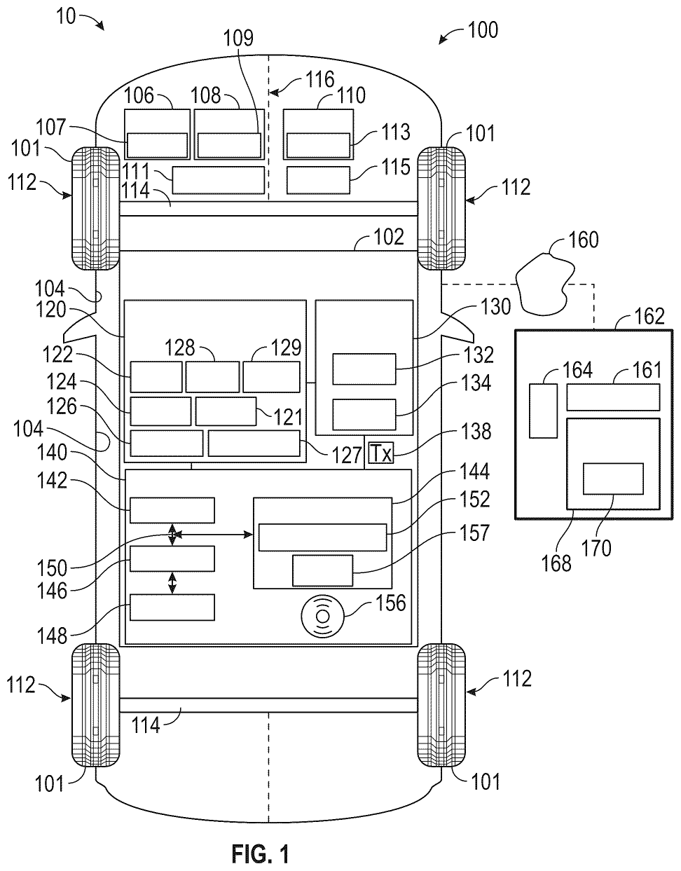

FIG. 1 illustrates a system 10, according to an exemplary embodiment. As depicted in FIG. 1, in an exemplary embodiment the system 10 includes a vehicle 100 along with a communications network 160 and a remote server 162, each described below.

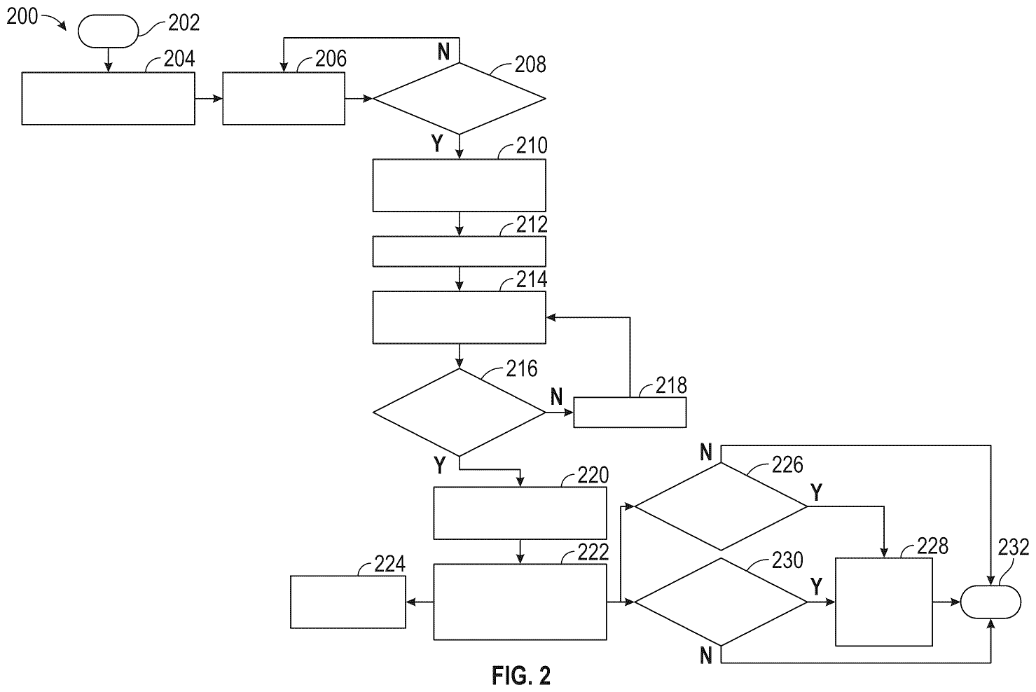

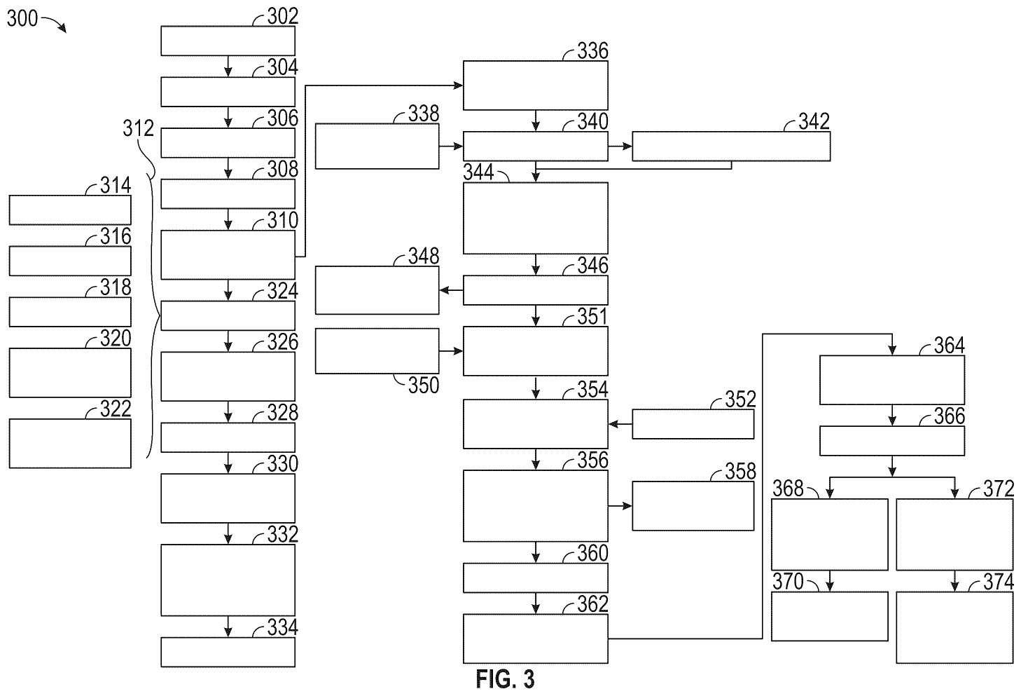

As described in greater detail further below, the vehicle 100 includes, among other components, a plurality of wheels 112 with corresponding tires 101 coupled thereto, along with a control system 102 for monitoring wear of the tires. As described in greater detail further below in connection with FIG. 1 as well as the process 200 of FIGS. 2 and 3, in various embodiments the control system 102 utilizes various different sensor data and processor-based determinations in monitoring the tread on the tires 101 and providing appropriate notifications based thereon to a user of the vehicle 100.

In various embodiments, the vehicle 100 comprises an automobile, such as any one of a number of different types of automobiles, such as, for example, a sedan, a wagon, a truck, sport utility vehicle (SUV), or the like. In certain embodiments, the vehicle 100 may also comprise a motorcycle or other vehicle, such as aircraft, spacecraft, watercraft, and so on, and/or one or more other types of mobile platforms (e.g., a robot and/or another mobile platform).

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a plurality of wheels 112. The wheels 112 are each rotationally coupled to the chassis 116 near a respective corner of the body 104 to facilitate movement of the vehicle 100. In one embodiment, the vehicle 100 includes four wheels 112, although this may vary in other embodiments (for example for trucks, motorcycles, and certain other vehicles).

Also in various embodiments, a corresponding tire 101 is mounted or otherwise disposed on or coupled to each of the wheels 112.

A drive system 110 is mounted on the chassis 116, and drives the wheels 112, for example via axles 114. In certain embodiments, the drive system 110 comprises a propulsion system having a motor 113 (e.g. that includes, in various embodiments, one or more combustion engines, electric motors, or the like)..

As depicted in FIG. 1, the vehicle also includes a braking system 106 and a steering system 108 in various embodiments. In exemplary embodiments, the braking system 106 controls braking of the vehicle 100 using braking components that are controlled via inputs provided by a driver (e.g., via a brake pedal 107) and/or autonomously via a control system (including the control system 102).

Also in exemplary embodiments, the steering system 108 controls steering of the vehicle 100 via steering components that are controlled via inputs provided by a driver (e.g., via a steering wheel 109) and/or autonomously via a control system (including the control system 102). In various embodiments, as described in greater detail further below in connection with the process 200 of FIGS. 2 and 3, the wheels 112 and tires 101 are rotated via inputs provided by the user and/or control system 102 for examining tread on the tires 101, in addition to rotation and other movement as part of the operation of the vehicle 100. In certain embodiments, the wheels 112 and tires 101 are rotated via one or more actuators 111 (e.g., in certain embodiments as part of a steering column of the steering system 108).

In certain embodiments, the vehicle 100 also includes one or more lighting systems 115 for illumination of one or more parts of the vehicle 100 and/or a roadway on which the vehicle 100 is being operated, and so on. In certain embodiments, the lighting system 115 is utilized for, among other purposes, illuminating the tires 101 for examination of tire tread thereof in accordance with the process 200 of FIGS. 2 and 3.

In the embodiment depicted in FIG. 1, the control system 102 is coupled to the braking system 106, the steering system 108, and the drive system 110, and controls operation and functionality thereof. Also in various embodiments, the control system 102 provides for monitoring of tread of the tires 101 of the vehicle 100, in accordance with the process 200 as FIGS. 2 and 3 and as described further below in connection therewith.

Also as depicted in FIG. 1, in various embodiments, the control system 102 includes a sensor array 120, a display 130, a transceiver 138, and a controller 140, as described in greater detail below.

In various embodiments, the sensor array 120 includes various sensors that obtain sensor data used for monitoring tread of the tires 101 of the vehicle 100, among other purposes. In the depicted embodiment, the sensor array 120 includes one or more steering sensors 122, tire pressure monitoring system (TPMS) sensors 124, vehicle dynamics sensors 127, and inertial measurement unit (IMU) sensors 128. In certain embodiments, the sensor array 120 may further include one or more other sensors 129.

In various embodiments, the steering sensors 122 detect measures of steering for the vehicle 100. In various embodiments, the steering sensors 122 detect engagement of the steering wheel 109 and/or angular movement of the wheels 112 and tires 101 (e.g., including via driver-initiated steering and/or automatic steering of the vehicle via the control system 102).

In various embodiments, the TPMS sensors 124 measure tire pressure of the tires 101.

In various embodiments, the cameras 126 are configured to obtain camera data (e.g., camera images) of the tires 101, including tread on the tires 101. In various embodiments, the cameras 126 are disposed at various locations of the vehicle 100 for different views of the tires 101. In certain embodiments, one or more first cameras 126 are disposed under one or more side view mirrors of the vehicle 100, whereas one or more second cameras 126 are disposed on an underbody of the vehicle 100 (under the body 104 of the vehicle 100). In certain embodiments, the cameras 126 may also be disposed at one or more other locations of the vehicle 100.

In various embodiments, the vehicle dynamics sensors 127 measure movement of the vehicle 100. In certain embodiments, the vehicle dynamics sensors 127 include one or vehicle speed sensors (e.g., wheel speed sensors), in addition to one or more brake sensors (e.g., to measure braking of the vehicle 100 via the braking system 106, among other possible sensors that measure movement of the vehicle 100.

In various embodiments, the IMU sensors 128 include one or more accelerometers and gyroscopes, among other possible sensors of or related to inertial measurement for the vehicle 100. It will be appreciated that some of these sensors may also overlap into one or more other categories (e.g., accelerometers may also be considered vehicle dynamics sensors 127 in certain embodiments, and so on).

In various embodiments, the other sensors 129 may include one or more input sensors that detect a user's engagement of a tire monitoring system or process for the vehicle 100. In addition, in certain embodiments, the other sensors 129 may also include one or more ultrasonic sensors, Lidar sensors, traction sensors, and/or one or more additional sensors that may also be utilized to obtain sensor data as to the tires 101, the tread thereof, and/or operations and/or conditions experienced by the vehicle 100, and so on. In addition, in certain embodiments, the other sensors 129 may also include one or more ambient light sensors that are configured to measure ambient light for determining whether there is sufficient light to take images of the tires 101, in addition to ambient or outside air temperature sensors, among other possible types of sensors.

In various embodiments, each of the sensors of the sensor array 120 are disposed within or on the vehicle 100, such as on the body 104 and/or on or more other components thereof.

In various embodiments, the display 130 provides information for the driver, including as to the implementing of an evasive steering maneuver by the control system 102 of the vehicle 100. As depicted in FIG. 1, in certain embodiments, the display 130 includes an audio component 132 (including one or more speakers) in addition to a visual (or video) component 134 (including one or more display screens). In certain embodiments, the display 130 may also include, among other possibilities, a display screen, or head up display, or the like. In various embodiments, the display 130 provides instructions for the user to manipulate the steering wheel 109 for examining the tread of the tires 101, in accordance with instructions provided by the controller 140. Also in various embodiments, the display 130 also provides results of the tire tread analysis, including recommendations for a user of the vehicle 100 as to replacing and/or rotating tires 101, and so on, based on instructions provided by the controller 140.

In various embodiments, the transceiver 138 is utilized for communication with the remote server 162 with the communications network 160, including for the analysis of tire tread. In various embodiments, the transceiver 138 performs these tasks in accordance with instructions provided by the controller 140.

In various embodiments, the controller 140 is coupled to the sensor array 120, the display 130, and the transceiver 138. In certain embodiments, the controller 140 is also coupled to the braking system 106, the steering system 108, and the drive system 110. In various embodiments, the controller 140 receives sensor data from the sensor array 120 and other data from the transceiver 138 (e.g., as to historical or reference tire data), interprets and processes the sensor data and other data in monitoring tread for the tires 101 of the vehicle 100, and providing notifications to a user of the vehicle via the display 130. In certain embodiments, the controller 140 also controls steering via the steering system 108 during tire testing for the purposes of obtaining tire tread images. In addition, in certain embodiments, the controller 140 may also control automatic operation of the braking system 106, steering system 108, drive system 110, and/or other vehicle systems (e.g., for autonomous or semi-autonomous operation of the vehicle 100 in certain embodiments and circumstances).

In various embodiments, the controller 140 provides these functions in accordance with the steps of the process 200 that is depicted in FIGS. 2 and 3 and described in greater detail further below in connection therewith.

As depicted in FIG. 1, in various embodiments, the controller 140 comprises a computer system (also referred to herein as computer system 140), and includes a processor 142, a memory 144, an interface 146, a storage device 148, and a computer bus 150.

The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 140 and the computer system of the controller 140, generally in executing the processes described herein, such as the process 200 of FIGS. 2 and 3 and as described further below in connection therewith.

The memory 144 can be any type of suitable memory, including various types of non-transitory computer readable storage medium. In certain examples, the memory 144 is located on and/or co-located on the same computer chip as the processor 142. In the depicted embodiment, the memory 144 stores the above-referenced program 152 along with stored values 157 (e.g., stored tire tread data and tire identification values, and also in certain embodiments look-up tables, thresholds, and/or other values with respect to the process 200).

The interface 146 allows communication to the computer system of the controller 140, for example from a system driver and/or another computer system, and can be implemented using any suitable method and apparatus. In one embodiment, the interface 146 obtains the various data from the sensor array 120, among other possible data sources. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 152 that executes one or more embodiments of one or more processes of the present disclosure, such as the steps of the process 200 of FIGS. 2 and 3 and as described further below in connection therewith. In another exemplary embodiment, the program product may be directly stored in and/or otherwise accessed by the memory 144 and/or a disk (e.g., disk 156), such as that referenced below.

The bus 150 serves to transmit programs, data, status and other information or signals between the various components of the computer system of the controller 140. The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program.

With continued reference to FIG. 1, in various embodiments the communications network 160 comprises one or more wireless communications networks and/or systems, such as one or more cellular networks, satellite-based networks, and/or other wireless networks.

Also in various embodiments, the remote server 162 is disposed physically remote from the vehicle 100. In various embodiments, the remote server 162 communicates with the vehicle 100 (among other vehicles, such as in a fleet in certain embodiments) via the communications network 160. In various embodiments, the remote server 162 records and maintains information pertaining to various vehicles (including the vehicle 100) and their respective tires 101, including information as to the respective types of tires 101, identification and tire tread measures thereof, and so on, and communicates these values with the vehicle 100 via communications to and from the vehicle 100. As depicted in FIG. 1, the remote server 162 includes, among other systems and components, a transceiver 164, processor 166, and memory 168 with stored values 170, which in various embodiments are similar to those described above with respect to the controller 140 of the vehicle 100.

FIG. 2 is a flowchart of a process 200 for monitoring tire tread in vehicles. In various embodiments, the process 200 can be implemented in connection with the system 10 of FIG. 1, including the vehicle 100 of FIG. 1 and the control system 102 thereof. The process 200 will also be described further below in connection with FIG. 3, which depicts an additional flowchart of the process 200 in greater detail.

As depicted in FIG. 2, in various embodiments the process 200 begins at 202. In certain embodiments, the process 200 begins when the vehicle 100 is ready for testing of the tires 101 (i.e., for monitoring the tread of the tires 101). In certain embodiments this may occur when a current vehicle drive or ignition cycle is complete; however, this may vary in other embodiments.

In various embodiments, the tire monitoring is initiated (step 204). In certain embodiments, this occurs when a user enables tire wear measurement by the control system 102 of FIG. 1, and/or when pre-set measurement time trigger has been met. However, this may vary in other embodiments.

In various embodiments, vehicle conditions are assessed (step 206). In various embodiments, step 206 includes a check or assessment of a charge of the vehicle 100, other vehicle conditions, and/or surroundings of the vehicle 100 as to whether an analysis of tire tread would be appropriate. In certain embodiments, such conditions include situations that would indicate potential wear on the tires 101 and/or of the tread thereof, such as driving on a rough road, frequent or quick braking and/or acceleration, typical wear for tires 101 of this particular type of vehicle 100, and so on.

In various embodiments, a determination is made as to whether the vehicle conditions have been met (step 208). In various embodiments, during step 208, the processor 142 determines, based on the assessments of step 206, whether the analysis of the tire tread is appropriate at the present time.

In various embodiments, if it is determined in step 208 that the vehicle conditions have not been yet, then the process 200 returns to step 206, and steps 206-208 thereafter repeat in new iterations until a determination is made in an iteration of step 208 that the vehicle conditions have been met. Conversely, once it is determined during an iteration of step 208 that the vehicle conditions have been met, the process 200 proceeds to step 210, in which tire tread measuring mode is initiated.

Once the tire tread measuring mode is initiated at step 210, steering is conducted (step 212). In various embodiments, the steering wheel 109 of the vehicle 100 is moved to enable the cameras 126 to obtain images of the tread on the tires 101. In certain embodiments, the processor 142 provides instructions via the display 130 for a user (e.g., driver) to follow to turn the steering wheel 109. In certain other embodiments, the processor 142 may provide instructions to automatically move the steering wheel 109, for example via instructions provided to the actuator 111 of FIG. 1. In either case, in various embodiments, the engagement and/or movement of the steering wheel 109 moves the wheels 112 of the vehicle 100 and allow for the clarity of view of the tread of the tires 101 via the one or more cameras 126 and repeatability of generation of the images of the tread (e.g., because the vehicle 100's sensors of the sensor array 120, including the vehicle 100's cameras 126, are utilized during the process 200).

In various embodiments, tire images are captured (step 214). In various embodiments, the cameras 126 are utilized to capture camera images of the tires 101, including the tread thereof, in accordance with instructions provided by the processor 142. In certain embodiments, one or more other sensors 129 (e.g., one or more ultrasonic sensors) may also be utilized for obtaining images of the tire tread. In various embodiments, the tire images (e.g., via the cameras 126 or in certain embodiments other sensors 129) are obtained at various different angles based on a calibratable road wheel angle threshold, including by rotating the steering wheel as described above.

In certain embodiments, a determination is made as to whether visibility is acceptable (step 216). In certain embodiments, during step 216, the processor 142 determines whether there is sufficient light to obtain clear images of the tires 101. In certain embodiments, this is determined via the cameras 126 and/or one or more other sensors 129 (e.g., one or more ambident light sensors, or the like).

In various embodiments, if it is determined in step 216 that visibility is not acceptable, then in various embodiments adjustments are made (step 218). In various embodiments, the lighting system 115 of FIG. 1 is illuminated to provide lighting for images of the tire tread, in accordance with instructions provided by the processor 142. In certain embodiments, one or more cameras 126 and/or other sensors may be adjusted to help enhance the images of the tire (e.g., by putting the cameras 126 in a night mode, or the like). In various embodiments, the process then returns to step 214, as new tire images are obtained, and the process continues in a new iteration.

Conversely, in various embodiments, if it is instead determined that the visibility is acceptable, then the process then proceeds instead to step 220. In various embodiments, during step 220, a tire tread profile is measured and stored. In various embodiments, the tire tread profile for the tires 101 is measured via image processing edge detection that is performed via the processor 142 for the tire images (e.g., the camera images in certain embodiments). In addition, various embodiments, the tire tread profile is stored in the memory 144 of FIG. 1 as stored values 157 therein for further use and processing.

In various embodiments, the tire measurements are compared with factory tire data (step 222). Specifically, in various embodiments, the tire tread profile of step 220 is compared with factory-supplied tire data as to typical or expected tire tread values for similar operating conditions as the vehicle 100 based on the type of tires 101 utilized in the vehicle 100. In various embodiments, the factory-supplied data is retrieved from the stored values 157 of the memory 144 of the vehicle and/or the stored values 170 of the memory 168 of the remote server 162 of FIG. 1.

Also in various embodiments, tire data is uploaded (step 224). In various embodiments, the tire measurements and profile of step 220, along with the comparisons of step 222, are transmitted to the remote server 162 for storage therein and for subsequent use in connection with the vehicle 100 and/or other vehicles (e.g., other vehicles with similar tires as the vehicle 100 of FIG. 1, in certain embodiments). In addition, in various embodiments, the related data as to conditions and events experienced by the vehicle 100 is likewise transmitted to the remote server 162, along with the tire data.

With continued reference to FIG. 2, also in various embodiments, a determination is made as to whether the tire tread is worn out (step 226). Specifically, in various embodiments, during step 226, the processor 142 determines whether a remaining tire tread of one or more tires 101 of the vehicle 100 are less than or equal to a predetermined value.

In various embodiments, if it is determined in step 226 that the tire tread is worn out (e.g., that the remaining tire tread is less than or equal to the predetermined value of step 226), then a notification is provided (step 228). In various embodiments, the notification is provided via the display 130 of FIG. 1, in accordance with instructions provided by the processor 142, as to the remaining tire tread level, along with one or more recommended courses of action (e.g., removing the tire). In various embodiments, the process then terminates at step 232.

Conversely, in various embodiments, if it is instead determined in step 226 that the tire tread is not worn out (e.g., that the remaining tire tread is greater than the predetermined value of step 226), then the process terminates at step 232, without any correction action or notification.

Also in various embodiments, a determination is made as to whether uneven tire wear is detected (step 230). Specifically, in various embodiments, during step 230, the processor 142 determines whether a remaining tire tread of one or more first tires 101 of the vehicle 100 is sufficiently different (e.g., with a difference that is greater than or equal to a predetermined threshold) from one or more second tires 101 of the vehicle 100.

In various embodiments, if it is determined in step 230 that there is uneven tire wear, then then a notification is provided (in a new iteration of step 228). In various embodiments, the notification is provided via the display 130 of FIG. 1, in accordance with instructions provided by the processor 142, as to the uneven tire wear, along with one or more recommended courses of action (e.g., rotating the tires). In various embodiments, the process then terminates at step 232.

Conversely, in various embodiments, if it is instead determined in step 230 that there is not uneven tire wear, then the process terminates at step 232, without any correction action or notification.

As noted above, FIG. 3 provides an additional flowchart with additional details as the process 200 of FIG. 2, in accordance with an exemplary embodiment.

As depicted in FIG. 3, in various embodiments, the tire monitoring is initiated by the user (step 302). In various embodiments, this corresponds to step 204 of FIG. 2.

In various embodiments, image data is obtained from various sensors (step 304). In various embodiments, the image data is obtained from various cameras 126 (such as an outside rearview mirror camera and/or an underbody camera) and/or other sensors (such as side Lidar sensors and/or other sensors in certain embodiments). In various embodiments, the image data is obtained as to the tires 101 as well as the roadway and/or other conditions surrounding the vehicle 100.

In addition, a determination is made as to whether TPMS data is detected for the tires (step 306). In certain embodiments, when available data, TPMS data, including tire pressure values, is obtained via the TPMS sensors 124 of FIG. 1.

Also in various embodiments, tire identification (ID) values are stored (step 308). In various embodiments, the ID values of the left front, right front, left rear, right rear (and any other applicable tires) are saved in the memory 144 of FIG. 1 as stored values 157 thereof.

In various embodiments, initial tire analysis is performed (step 310). In various embodiments, the initial tire analysis is performed by the processor 142 based on the sensor data, including as to tire tread values at an initial, current value (e.g., with an initial counter value that is equal to zero).

In various embodiments, calibration is performed (step 312). Specifically, in various embodiments, the processor 142 performs calibration for the sensors and sensor data (including tire tread values) at set intervals (e.g., every 10,000 km in certain embodiments, although this may vary in other embodiments). Also in various embodiments, the calibration is adjusted based on prognostics data of step 312 as appropriate. In various embodiments, the prognostics data of step 312 includes, among other possible data: (i) anti-lock braking system (ABS) data 314 (e.g., as to ABS activations, including a number or frequency of skid stops, sudden braking, and the like); (ii) accelerations 316 (e.g., including accelerations with pedal position greater than a predetermined threshold, such as ninety percent in an exemplary embodiment); (iii) road terrain 318 (e.g., measures of operation in distance on road roads versus asphalt, or the like); (iv) outside air temperature 320 (e.g., including warm weather above a first predetermined threshold such as six degrees Celsius in one embodiment, as compared with cold weather below a second predetermined threshold such as negative six degrees Celsius in one embodiment, and so on); and (v) low tire pressure readings 322, among other possible prognostics data.

Also in various embodiments, tire pressure re-learning is detected (step 326). In various embodiments, during step 326, the processor 142 determines whether any tire changes have occurred (e.g., replacement or rotating of the tires) based on detected TPMS learning. Specifically, in various embodiments, the TPMS data and learning is utilized for identification of a particular tire for recognizing whether the particular tire has been moved (e.g., such as when the particular tire has been replaced or rotated).

In various embodiments, the tire ID is updated (step 328). Specifically, in various embodiments, the processor 142 updates the tire ID in memory for each tire 101 of the vehicle 100 to reflect any tire changes (e.g., replacement or rotation), and so on.

In various embodiments, tire patterns are evaluated (step 330). Specifically, in various embodiments, the processor 142 evaluates the current tire patterns (including tread) based on the most recent updated images and sensor data and compares them to the stored values form the memory.

Also in various embodiments, the user is asked regarding tire replacements (step 332). Specifically, in various embodiments, the processor 142 prompts the user of the vehicle 100, via the display 130 of FIG. 1, as to whether tire replacements have occurred, including use of winter tires when entering colder temperatures and/or regions, and so on.

Also in various embodiments, if the tire replacements are confirmed, then the tire ID for the replacement tires (e.g., the winter tires) is stored by the processor 142 in the memory (step 334).

With reference back to step 310, after the initial tire analysis is performed (with the counter initiated to zero) in step 310, a determination is also made in step 336 as to whether the vehicle 100 has sufficient charge to perform tire movement and analysis. In various embodiments, the determination of step 336 is performed by the processor 142 based on whether the vehicle charge is greater than a predetermined threshold (e.g., twenty percent in one exemplary embodiment, although this may vary in other embodiments) while the vehicle 100 is plugged in.

In addition, various embodiments, ambient light sensor data is obtained at step 338, and a determination is made at step 340 as to whether ambient light conditions are sufficient for tire images and monitoring. In various embodiments, if it is determined that the ambient light is insufficient, then the lighting system is turned on for illumination of the tires and tire thread for image collection (step 342), after which the process proceeds to step 344 (discussed below). Otherwise, if the light is sufficient, the process proceeds direction to step 344, without the illumination of step 342.

In various embodiments, during step 344, tire color cleanliness is determined. Specifically, in various embodiments, during step 344, the processor 142 determines color cleanliness for the tires are reflected in the sensor images (e.g., camera images). In various embodiments, the color cleanliness may refer to color differences in the tire width, for example including the color white representing snow, the color brown representing mud, and so on. In various embodiments, the processor 142 also determines a correlation to weather reports (such a snow storm, dust storm, or the like) for verification. Also in various embodiments the processor 142 adjusts the tire tread pattern based on the determining of the decolorization (e.g. to account for the decolorization, and so on). For example, in various embodiments, when the tires 101 are covered with mud, snow, or the like, the adjustment helps to ensure that this is not falsely interpreted as bald or overly worn tires 101, and so on.

In various embodiments, edge detection is performed (step 346). In various embodiments, the edge detection is performed by the processor 142 in order to determine the tire tread pattern and store this in memory (such as in the stored values 157 of the memory 144 of FIG. 1).

Also in various embodiments, the tire tread profile is generated and stored (step 348). In various embodiments, the processor 142 generates and stores the tire thread profile through image processing of the sensor images (e.g., camera images) of the tires through processing and edge detection.

Also in certain embodiments, various sensors are utilized to detect object obstructions (step 350). Specifically, in certain embodiments, one or more cameras (e.g., outside rear view mirror cameras) and/or other sensors (e.g., side ultrasonic sensors) are utilized for detection and/or accounting for objects in proximity to the tires 101 that may be obstructing the images of the tire thread.

Also in certain embodiments, a sweep is performed (step 351). In certain embodiments, a tire sweep is performed within a predetermined object distance to remove or account for the objects that may be obstructing the images of the tires 101.

Also in various embodiments, steer ratio data is obtained (step 352). Specifically, in various embodiments, the processor 142 obtains steer ratio data from the sensor array 120 as to a correlation between steering wheel angle and road wheel angle, including for determining whether the tires and wheels are ready for turning for tire wear monitoring.

In various embodiments, the steering wheel is rotated (step 354). In various embodiments, once it is determined that conditions are appropriate for turning the tires and wheels for tire wear monitoring, the steering wheel is rotated accordingly. In various embodiments, once steering availability is confirmed for the front wheels, the front wheels are rotated slowly by a certain amount of degrees (referred to herein as “X” degrees) that allows the tire tread to be fully exposed and mapped accordingly. Similar to the discussion above, in certain embodiments, the steering is performed autonomously via instructions provided by the processor 142, whereas in other embodiments the processor 142 may provided instructions via the display 130 of FIG. 1 for the user to perform the steering. In either case, in various embodiments, sensor images (e.g., camera images) are obtained as to the tire tread of the front tires as the front wheels are rotated accordingly at various different angles.

Also in various embodiments, rear wheel steering availability is similarly confirmed (step 356), after which the rear wheels are similarly rotated (step 358) and sensor images (e.g., camera images) are similarly obtained as to the tire tread of the rear wheels as the as the rear wheels are rotated accordingly at various different angles.

In various embodiments, the tire depths are calculated (step 360). Specifically, in various embodiments, the processor 142 calculates the tire tread depth for the different tires based on the sensor (e.g., camera) images o the tires at the various different angles. In various embodiments, these calculations are performed via the processor based on a calibrated camera projection matrix.

Also in various embodiments, during step 362 final values of the tire tread depths are calculated via the camera projection matrix and compared to one another and to reference images (e.g., from historical data and/or factory-provided data, or the like). In various embodiments, this is performed via the processor 142 of FIG. 1.

Also in various embodiments, tire replacement time is estimated or updated (step 364). Specifically, in various embodiments, the processor 142 estimates and/or updates an mount of time in which the tires are expected to remain in usable condition, and/or an amount of time and/or distance of continued use in which it is likely to be recommended to replace one or more of the tires, based on the tread depth. In various embodiments, this determination may also be made utilized stored values 157 in the memory 144, such as one or more look-up tables, historical data, factory-provided guidelines, or the like.

Also in various embodiments, a determination is made as to whether uneven wear is detected (step 366). Specifically, in various embodiments, and similar to the discussion above, uneven wear may be detected when a difference between wear or tire tread among different tires exceeds a predetermined difference thresholds.

In various embodiments, if it is determined in step 366 that there is uneven wear, then a determination is made as to whether overall front tire wear is greater than rear tire wear (step 368). In various embodiments, if is determined in step 366 that front tire wear is greater than rear tire wear, then in various embodiments, a tire rotation may be recommended (step 370), including a front to rear tire swap. In various embodiments, this recommendation is provided via instructions provided from the processor 142 to the user via the display 130 of FIG. 1.

Also in various embodiments, a determination is also made as to whether left side wear is significantly different from right side wear (step 372). In various embodiments, if is determined in step 372 that the left side tire wear is greater than the right side tire wear (e.g., that the tire tread depth is less on the left tires as compared with the right tires), then in various embodiments a wheel alignment is recommended (step 374). In various embodiments, this recommendation is provided via instructions provided from the processor 142 to the user via the display 130 of FIG. 1. Also in certain embodiments, wheel alignment may also be recommended in other situations, such as other types of uneven tire wear, and so on.

Accordingly, methods, systems, and vehicles are provided for monitoring tire tread depth using camera and/other sensor data in various embodiments, including images of the tire tread taken using cameras and/or other sensors while selectively rotating the steering wheel of the vehicle under controlled images, and utilizing various other sensor data as to operating and environmental conditions for the vehicle.

It will be appreciated that the systems, vehicles, and methods may vary from those depicted in the Figures and described herein. For example, the vehicle 100 of FIG. 1, including the control system 102 and/or other components thereof, may vary in different embodiments from that depicted in FIG. 1 and/or described above in connection therewith. It will similarly be appreciated that the steps of the process 200 and implementations thereof may differ from those depicted in FIGS. 2 and 3, and/or that various steps of the process 200 may occur concurrently and/or in a different order than that depicted in FIGS. 2 and 3 and/or described above in connection therewith.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of monitoring tire tread for tires of a vehicle, the method comprising:
obtaining, via one or more sensors of the vehicle, images of tread for the tires of the vehicle after tire wear monitoring is initiated for the vehicle;
determining, via a processor that is coupled to the one or more sensors, a depth of the tread for the tires of the vehicle, using the images, when tire wear monitoring is initiated for the vehicle; and
providing a notification for a user of the vehicle as to the depth of the tread for the tires of the vehicle, based on instructions provided by the processor.

2. The method of claim 1, wherein:
the step of obtaining the images of the tread comprises obtaining the images from one or more cameras of the vehicle; and
the step of determining the depth of the tread comprises determining, via the processor, the depth of the tread using camera images from the one or more cameras in connection with a calibrated camera projection matrix.

3. The method of claim 2, wherein the step of obtaining the images of the tread comprises obtaining the images from a plurality of cameras of the vehicle, including a first camera proximate a side view mirror of the vehicle, and further comprising a second camera on an underbody of the vehicle.

4. The method of claim 2, further comprising:
providing, via the processor, instructions for movement of wheels of the vehicle during initiating of monitoring of the tread, to thereby allow for clarity of view of the tread of the tires via the one or more cameras and repeatability of generation of the images of the tread.

5. The method of claim 4, wherein the instructions are provided via the processor to the user of the vehicle via a display of the vehicle for the user to engage a steering wheel of the vehicle, to thereby move the wheels of the vehicle and allow for the clarity of view of the tread of the tires via the one or more cameras and repeatability of generation of the images of the tread.

6. The method of claim 4, wherein the instructions are provided via the processor to one or more actuators of the vehicle for autonomous movement of the wheels of the vehicle and allow for the clarity of view of the tread of the tires via the one or more cameras and repeatability of generation of the images of the tread.

7. The method of claim 1, further comprising:
storing, in computer memory, a tire tread pattern for the tires based on the images of the tread, in accordance with instructions provided by the processor.

8. The method of claim 7, further comprising:
determining, via the processor, decolorization of the tires based on the images; and
adjusting, via the processor, the tire tread pattern based on the determining of the decolorization for storing in the computer memory.

9. The method of claim 7, further comprising:
determining, via the processor based on the tire tread pattern, whether tire rotation, replacement, or both are recommended, including based on whether the tire tread pattern is representative of uneven tread depth between front tires versus rear tears, between left tires versus right tires, or both.

10. The method of claim 1, further comprising:
storing, in computer memory, an identification of a tire pressure monitoring system (TPMS) identification for the tires, for identification of a particular tire for recognizing whether the particular tire has been replaced or rotated, in accordance with instructions provided by the processor.

11. The method of claim 1, further comprising:
determining, via the processor, whether sufficient light is present for obtaining the images of the tread; and
automatically activating a light system outside the vehicle for illumination of the tires while the images of the tread are obtained, in accordance with instructions provided by the processor.

12. The method of claim 1, further comprising:
obtaining additional sensor data from one or more additional sensors of the vehicle, including as to values of time of acceleration, braking, tire pressure, terrain of roadways in which the vehicle has travelled, and outside air temperature surrounding the vehicle as the vehicle has been operated;
wherein the tire wear monitoring is initiated with a frequency that is based upon the additional sensor data for the vehicle, including each of the acceleration, braking, tire pressure, terrain of roadways in which the vehicle has travelled, and the outside air temperature surrounding the vehicle as the vehicle has been operated.

13. A system for monitoring tire tread for tires of a vehicle, the system comprising:
one or more sensors of the vehicle, the one or more sensors configured to obtain images of tread for the tires of the vehicle after tire wear monitoring is initiated for the vehicle; and
a processor that is coupled to the one or more sensors and that is configured to at least facilitate:
determining a depth of the tread for the tires of the vehicle, using the images, when tire wear monitoring is initiated for the vehicle; and
providing a notification for a user of the vehicle as to the depth of the tread for the tires of the vehicle, based on instructions provided by the processor.

14. The system of claim 13, wherein:
the one or more sensors comprise a plurality of cameras of the vehicle, including:
a first camera disposed proximate a side view mirror of the vehicle; and
a second camera disposed on an underbody of the vehicle; and
the processor is further configured to at least facilitate determining the depth of the tread using camera images from the plurality of cameras in connection with a calibrated camera projection matrix.

15. The system of claim 14, wherein the processor is further configured to at least facilitate providing instructions for movement of wheels of the vehicle during initiating of monitoring of the tread, to thereby allow for clarity of view of the tread of the tires via the plurality of cameras. and repeatability of generation of the images of the tread.

16. The system of claim 13, wherein the processor is further configured to at least facilitate:
storing, in computer memory, a tire tread pattern for the tires based on the images of the tread, in accordance with instructions provided by the processor; and
determining, based on the tire tread pattern, whether tire rotation, replacement, or both are recommended, including based on whether the tire tread pattern is representative of uneven tread depth between front tires versus rear tears, between left tires versus right tires, or both.

17. The system of claim 13, further comprising:
one or more additional sensors of the vehicle that are configured to obtain additional sensor data, including as to values of time of acceleration, braking, tire pressure, terrain of roadways in which the vehicle has travelled, and outside air temperature surrounding the vehicle as the vehicle has been operated;
wherein the processor is further configured to at least facilitate initiating the tire wear monitoring with a frequency that is based upon the additional sensor data for the vehicle, including each of the acceleration, braking, tire pressure, terrain of roadways in which the vehicle has travelled, and the outside air temperature surrounding the vehicle as the vehicle has been operated.

18. A vehicle comprising:
one or more wheels;
one or more tires disposed on the one or more wheels;
one or more sensors that are configured to obtain images of tread for the tires after tire wear monitoring is initiated for the vehicle; and
a processor that is coupled to the one or more sensors and that is configured to at least facilitate:
determining a depth of the tread for the tires of the vehicle, using the images, when tire wear monitoring is initiated for the vehicle; and
providing a notification for a user of the vehicle as to the depth of the tread for the tires of the vehicle, based on instructions provided by the processor.

19. The vehicle of claim 18, wherein:
the one or more sensors comprise a plurality of cameras of the vehicle, including:
a first camera disposed proximate a side view mirror of the vehicle; and
a second camera disposed on an underbody of the vehicle; and
the processor is further configured to at least facilitate:
providing instructions for movement of wheels of the vehicle during initiating of monitoring of the tread, to thereby allow for clarity of view of the tread of the tires via the plurality of cameras and repeatability of generation of the images of the tread; and
determining the depth of the tread using camera images from the plurality of cameras in connection with a calibrated camera projection matrix.

20. The vehicle of claim 18, further comprising:
one or more additional sensors that are configured to obtain additional sensor data for the vehicle, including as to values of time of acceleration, braking, tire pressure, terrain of roadways in which the vehicle has travelled, and outside air temperature surrounding the vehicle as the vehicle has been operated;
wherein the processor is further configured to at least facilitate initiating the tire wear monitoring with a frequency that is based upon the additional sensor data for the vehicle, including each of the acceleration, braking, tire pressure, terrain of roadways in which the vehicle has travelled, and the outside air temperature surrounding the vehicle as the vehicle has been operated.
